(19) United States
(12) Patent Application Publication
(10) Pub. No.: US 2021/0133474 A1
(43) Pub. Date: May 6, 2021

(54) IMAGE PROCESSING APPARATUS, SYSTEM, METHOD, AND NON-TRANSITORY COMPUTER READABLE MEDIUM STORING PROGRAM

(71) Applicant: NEC Corporation, Minato-ku, Tokyo (JP)

(72) Inventor: Azusa SAWADA, Tokyo (JP)

(73) Assignee: NEC Corporation, Minato-ku, Tokyo (JP)

(21) Appl. No.: 17/055,819

(22) PCT Filed: May 18, 2018
(86) PCT No.: PCT/JP2018/019291

§ 371 Date: Nov. 16, 2020

(51) Int. Cl. G06K 9/20; G06K 9/62; G06T 7/73

(52) U.S. Cl. CPC G06K 9/2054; G06T 2207/20081; G06T 7/74; G06K 9/6262

(57) ABSTRACT

An image processing apparatus (1) includes: a determination unit (11) configured to determine, using a ground truth, a degree to which each of a plurality of candidate areas that correspond to respective predetermined positions common to the plurality of images includes a corresponding ground truth area for each of the plurality of images; and a first learning unit (12) configured to learn, based on a plurality of feature maps extracted from each of the plurality of images, a set of the results of the determination made by the determination means, and the ground truth, a parameter (14) used when an amount of positional deviation between the position of the detection target included in a first image captured by a first modal and the position of the detection target included in a second image captured by a second modal is predicted.

### TECHNICAL FIELD

The present disclosure relates to an image processing apparatus, a system, a method, and a program, and more specifically, relates to an image processing apparatus, a system, a method, and a program in an object detection method that receives multimodal images.

### BACKGROUND ART

In recent years, studies of techniques of object detection methods for performing, for a plurality of detection target objects shown in an image (the detection targets may also be non-objects), detection of an area and classification of attributes, and outputting results regarding what is shown in which position in the image have been advancing. For example, Patent Literature 1 discloses a technique of Faster Regions with Convolutional Neural Network (CNN) features (R-CNN) that uses a convolutional neural network. The Faster R-CNN, which is a detection method capable of dealing with a variety of objects, is configured to calculate candidates for areas to be detected (hereinafter they will be referred to as detection candidate areas), and then identify and output them. Specifically, after the system disclosed in Patent Literature 1 receives the input image, this system first extracts feature maps by a convolutional neural network. Then this system calculates detection candidate areas by a Region Proposal Network (hereinafter it will be referred to as an RPN) based on the extracted feature maps. After that, this system identifies each of the detection candidate areas based on the calculated detection candidate areas and the feature maps.

Meanwhile, when, for example, only images of visible light are used when an object is detected, it becomes difficult to detect the object when lighting conditions are poor, such as at night. In order to address this problem, the object is detected using multimodal images in which visible light is combined with another modal such as infrared light or a distance image, whereby it is possible to maintain or improve the performance (accuracy) of the object detection in a greater variety of situations. Non-Patent Literature 1 is an example in which the aforementioned Faster R-CNN is applied to multimodal images. The input image in Non-Patent Literature 1 is a dataset of a visible image and a far infrared image acquired so that there is no positional deviation between them. In Non-Patent Literature 1, modal fusion is performed by a weighted sum for each pixel at one position in the map in the middle of the process of calculating the feature map from the images of the respective modals. The operation of the RPN is similar to that when a single modal is used. In this operation, a score indicating the likelihood of being the detection target and areas common to modals in which predetermined rectangular areas are improved by regression are output from the feature map of the input (either the feature map before the modal fusion or the one after the modal fusion is available).

As techniques that relate to the object detection or image processing, the following documents can be, for example, listed. Patent Literature 2 discloses a technique for generating image data on a captured image having an improved performance, compared with captured images generated individually by a plurality of imaging sections, using the image data on the captured images generated individually. Further, Patent Literature 3 discloses a technique for extracting feature amounts from a plurality of areas in an image and generating feature maps.

Further, Patent Literature 4 discloses a technique related to an image processing system for generating a synthetic image for specifying a target area from multimodal images. The image processing system disclosed in Patent Literature 4 first generates a plurality of cross-sectional images obtained by slicing a tissue specimen at predetermined slice intervals for each of stains. Then this image processing system synthesizes, for cross-sectional images of different stains, images for each corresponding cross-sectional position.

Further, Patent Literature 5 discloses a technique related to an image recognition apparatus for recognizing the category of an object in an image and its region. The image recognition apparatus disclosed in Patent Literature 5 divides an input image into multiple local regions and discriminates the category of the object for each local region using a discriminant criterion having preliminarily been learned regarding a detected object. Further, Patent Literature 6 discloses a technique for detecting overlapping of another object at arbitrary position of an object recognized from an imaged image.

Further, Non-Patent Literature 2 and 3 disclose techniques for generating images with a higher visibility from multimodal images. Further, Non-Patent Literature 4 discloses a technique related to a correlation score map of multimodal images.

### CITATION LIST

### Patent Literature

[Patent Literature 1] United States Patent Application Publication No. 2017/0206431
[Patent Literature 2] International Patent Publication No. WO 2017/208536
[Patent Literature 3] Japanese Unexamined Patent Application Publication No. 2017-157138
[Patent Literature 4] Japanese Unexamined Patent Application

Publication No. 2017-068308
[Patent Literature 5] Japanese Unexamined Patent Application Publication No. 2016-018538
[Patent Literature 6] Japanese Unexamined Patent Application Publication No. 2009-070314

### Non-Patent Literature

[Non-Patent Literature 1] Jingjing Liu, Shaoting Zhang, Shu Wang, Dimitris N. Metaxas. “Multispectral Deep Neural Networks for Pedestrian Detection.” In Proceedings of the British Machine Vision Conference, 2016.
[Non-Patent Literature 2] Shibata, Takashi, Masayuki Tanaka, and Masatoshi Okutomi. “Misalignment-Robust Joint Filter for Cross-Modal Image Pairs.” Proceedings of the IEEE Conference on Computer Vision and Pattern Recognition. 2017.
[Non-Patent Literature 3] Shibata, Takashi, Masayuki Tanaka, and Masatoshi Okutomi. “Unified image fusion based on application-adaptive importance measure.” Image Processing (ICIP), 2015 IEEE International Conference on. IEEE, 2015.
[Non-Patent Literature 4] S. Kim, D. Min, B. Ham, S. Ryu, M. N. Do, and K. Sohn. “Dasc: Dense adaptive self-correlation descriptor for multi-modal and multi-spectral correspondence.” In Proc. of IEEE Conf. on Computer Vision and Pattern Recognition (CVPR), 2015.

### SUMMARY OF INVENTION

### Technical Problem

There is a problem in the technique disclosed in Non-Patent Literature 1 that a degree of accuracy of recognizing an image of one detection target from a set of images captured by the plurality of different modals is insufficient.

The reason therefor is that, first, there is a deviation in the optical axis of the camera between the modals in typical image-capturing devices and the deviation of the optical axis (parallax) cannot be preliminary corrected by image processing, which causes a positional deviation between modals due to the parallax. Another reason is that, in the technique disclosed in Non-Patent Literature 1, it is assumed that there is no positional deviation between modals for the multimodal images to be input. Further, even when a plurality of images are captured while switching a plurality of modals by one camera, positional deviation between modals still occurs due to a movement of the detection target or the camera. The techniques disclosed in Patent Literature 1 to 6 and Non-Patent Literature 2 to 4 do not solve the aforementioned problem.

The present disclosure has been made in order to solve the aforementioned problem and aims to provide an image processing apparatus, a system, a method, and a program for improving a degree of accuracy of recognizing the image of one detection target from a set of images captured by the plurality of different modals.

### Solution to Problem

An image processing apparatus according to a first aspect of the present disclosure includes: determination means for determining, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images; and a first learning means for learning, based on a plurality of feature maps extracted from each of the plurality of images, a set of the results of the determination made by the determination means for each of the plurality of images, and the ground truth, a first parameter used when an amount of positional deviation between the position of the detection target included in a first image captured by a first modal and the position of the detection target included in a second image captured by a second modal is predicted and storing the learned first parameter in a storage means.

An image processing system according to a second aspect of the present disclosure includes: a first storage means for storing a plurality of images obtained by capturing a specific detection target by a plurality of different modals and a ground truth associating a plurality of ground truth areas, each ground truth area including a detection target in each of the plurality of images, with a ground truth label attached to the detection target; a second storage means for storing a first parameter that is used to predict an amount of positional deviation between a position of the detection target included in a first image captured by a first modal and a position of the detection target included in a second image captured by a second modal; determination means for determining, using the ground truth, a degree to which each of a plurality of candidate areas that correspond to respective predetermined positions common to the plurality of images includes a corresponding ground truth area for each of the plurality of images; and a first learning means for learning, based on a plurality of features maps extracted from each of the plurality of images, a set of the results of the determination made by the determination means for each of the plurality of images, and the ground truth, the first parameter and storing the learned first parameter in the second storage means.

In an image processing method according to a third aspect of the present disclosure, an image processing apparatus performs the following processing of: determining, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images; learning, based on a plurality of feature maps extracted from each of the plurality of images, a set of the results of the determination for each of the plurality of images, and the ground truth, a first parameter used when an amount of positional deviation between the position of the detection target included in a first image captured by a first modal and the position of the detection target included in a second image captured by a second modal is predicted; and storing the learned first parameter in a storage apparatus.

An image processing program according to a fourth aspect of the present disclosure causes a computer to execute the following processing of: determining, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images; learning, based on a plurality of feature maps extracted from each of the plurality of images, a set of the results of the determination for each of the plurality of images, and the ground truth, a first parameter used when an amount of positional deviation between the position of the detection target included in a first image captured by a first modal and the position of the detection target included in a second image captured by a second modal is predicted; and storing the learned first parameter in a storage apparatus.

### Advantageous Effects of Invention

According to the present disclosure, it is possible to provide an image processing apparatus, a system, a method, and a program for improving a degree of accuracy of recognizing an image of one detection target from a set of images captured by a plurality of different modals.

### BRIEF DESCRIPTION OF DRAWINGS

FIG. 1 is a functional block diagram showing a configuration of an image processing apparatus according to a first example embodiment;

FIG. 2 is a flowchart for describing a flow of an image processing method according to the first example embodiment;

FIG. 3 is a block diagram showing a hardware configuration of the image processing apparatus according to the first example embodiment;

FIG. 4 is a block diagram showing a configuration of an image processing system according to a second example embodiment;

FIG. 5 is a block diagram showing internal configurations of respective learning blocks according to the second example embodiment;

FIG. 6 is a flowchart for describing a flow of learning processing according to the second example embodiment;

FIG. 7 is a block diagram showing a configuration of an image processing system according to a third example embodiment;

FIG. 8 is a block diagram showing an internal configuration of an image recognition processing block according to the third example embodiment;

FIG. 9 is a flowchart for describing a flow of object detection processing including image recognition processing according to the third example embodiment; and

FIG. 10 is a diagram for describing a concept of object detection according to the third example embodiment.

### DESCRIPTION OF EMBODIMENTS

Hereinafter, with reference to the drawings, example embodiments of the present disclosure will be described in detail. Throughout the drawings, the same or corresponding components are denoted by the same reference symbols and overlapping descriptions will be omitted as appropriate for the sake of clarity of the description.

### First Example Embodiment

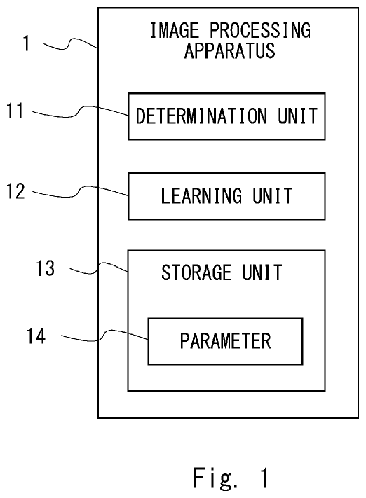

FIG. 1 is a functional block diagram showing a configuration of an image processing apparatus 1 according to a first example embodiment. The image processing apparatus 1 is a computer that performs image processing on a set of images captured by a plurality of modals. Note that the image processing apparatus 1 may be formed of two or more information processing apparatuses.

The set of images captured by the plurality of modals means a set of images of a specific detection target captured by a plurality of different modals. The term “modal” herein is an image form and indicates, for example, an image-capturing mode of an image-capturing device by visible light, far-infrared light or the like. Therefore, images captured by one modal indicate data of images captured by one image-capturing mode. Further, the set of images captured by the plurality of modals may be simply referred to as a multimodal image and may also be referred to as “images of the plurality of modals” or more simply “plurality of images” in the following description. The detection target, which is an object reflected in the captured image, is a target object that should be detected by image recognition. However, the detection target is not limited to an object and may include a non-object such as a backdrop.

The image processing apparatus 1 includes a determination unit 11, a learning unit 12, and a storage unit 13. The determination unit 11 is determination means for determining, the degree to which each of a plurality of candidate areas that correspond to respective predetermined positions that are common between images of the plurality of modals includes a corresponding ground truth area for each of the plurality of images using a ground truth. The “ground truth” (it may also be referred to as a “correct answer label”) is information in which a plurality of ground truth areas (the ground truth area(s) may also be referred to as “correct answer area(s)”) including a common detection target in each of the images of the plurality of modals and a ground truth label attached to this detection target are associated with each other. Further, the “ground truth label” (it may be simply referred to as a “label”), which is information indicating the type of the detection target, can be referred to as a class or the like.

The learning unit 12 is a first learning means for learning a parameter 14 that is used to predict an amount of positional deviation of a specific detection target between a plurality of images and storing the learned parameter 14 in the storage unit 13. The learning unit 12 performs learning based on a plurality of feature maps extracted from the respective images of the plurality of modals, a set of the results of the determination for each of the plurality of images by the determination unit 11, and the ground truth. Further, the “amount of positional deviation” is a difference between the position of the detection target included in a first image captured by a first modal and the position of the detection target included in a second image captured by a second modal. Further, the parameter 14 is a setting value that is used for a model that predicts the aforementioned amount of positional deviation. The “learning” indicates machine learning. That is, the learning unit 12 adjusts the parameter 14 in such a way that the value obtained by the model in which the parameter 14 is set approaches a target value based on the ground truth based on the plurality of feature maps, the set of the results of the determination, and the ground truth. The parameter 14 may be a set of a plurality of parameter values in this model.

The storage unit 13 is a storage area that is achieved by a storage apparatus and stores the parameter 14.

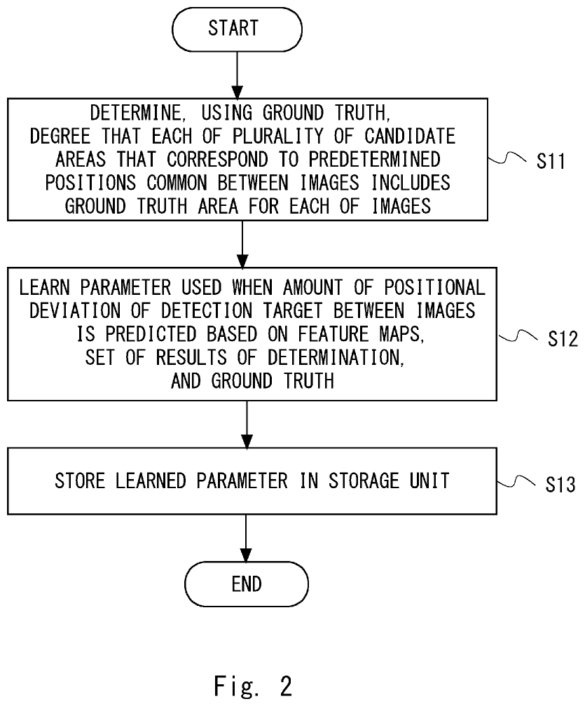

FIG. 2 is a flowchart for describing a flow of an image processing method according to the first example embodiment. First, the determination unit 11 determines the degree to which each of a plurality of candidate areas that correspond to respective predetermined positions that are common between images of the plurality of modals includes a corresponding ground truth area for each of the plurality of images using the ground truth (S11). Next, the learning unit 12 learns the parameter 14 used when the amount of positional deviation of a specific detection target between a plurality of images is predicted based on the plurality of feature maps, the set of the results of the determination in Step S11, and the ground truth (S12). Then the learning unit 12 stores the parameter 14 learned in Step S12 in the storage unit 13 (S13).

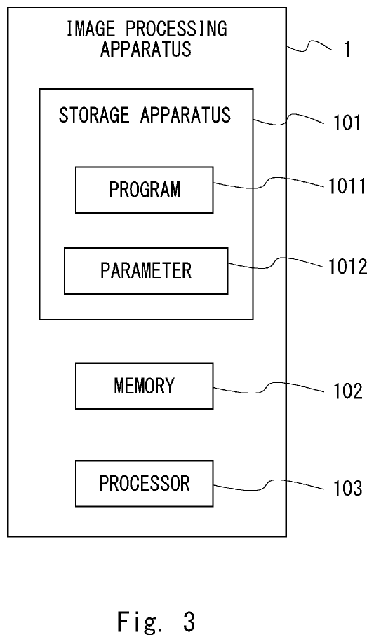

FIG. 3 is a block diagram showing a hardware configuration of the image processing apparatus 1 according to the first example embodiment. The image processing apparatus 1 at least includes, as a hardware configuration, a storage apparatus 101, a memory 102, and a processor 103. The storage apparatus 101, which corresponds to the aforementioned storage unit 13, stores, for example, a non-volatile storage apparatus such as a hard disk or a flash memory. The storage apparatus 101 at least stores a program 1011 and a parameter 1012. The program 1011 is a computer program in which at least the aforementioned image processing according to this example embodiment is implemented. The parameter 1012 corresponds to the aforementioned parameter 14. The memory 102, which is a volatile storage apparatus such as a Random Access Memory (RAM), is a storage area for temporarily holding information when the processor 103 is operated. The processor 103, which is a control circuit such as a Central Processing Unit (CPU), controls each component of the image processing apparatus 1. Then the processor 103 loads the program 1011 to the memory 102 from the storage apparatus 101 and executes the loaded program 1011. Accordingly, the image processing apparatus 1 achieves the functions of the aforementioned determination unit 11 and learning unit 12.

Typically, the positional deviation between images due to the deviation of the optical axis (parallax) depends on the distance between the target in which the magnitude of the positional deviation with respect to each point is shown and a light receiving surface. Therefore, it is impossible to completely make correction by global conversion as two-dimensional images. In particular, for an object at a short distance with a large parallax compared to the distance between cameras, a difference in visibility occurs due to the difference in the angles or shieling by another object.

In order to address the above problem, by using a prediction model of the positional deviation between modals that uses parameters learned by this example embodiment, it is possible to predict the positional deviation of the set of images of one detection target captured by the plurality of different modals. Then, in the process of identifying the feature maps that correspond to the detection candidate areas selected from the set of images, the amount that corresponds to the predicted positional deviation can be shifted. Accordingly, it is possible to fuse the feature maps from the respective modals spatially correctly regardless of the positional deviation and to prevent reduction in the detection performance due to the positional deviation. Therefore, by taking into account the predicted positional deviation, it is possible to improve the degree of accuracy of recognizing images of the detection target from the above set of images.

### Second Example Embodiment

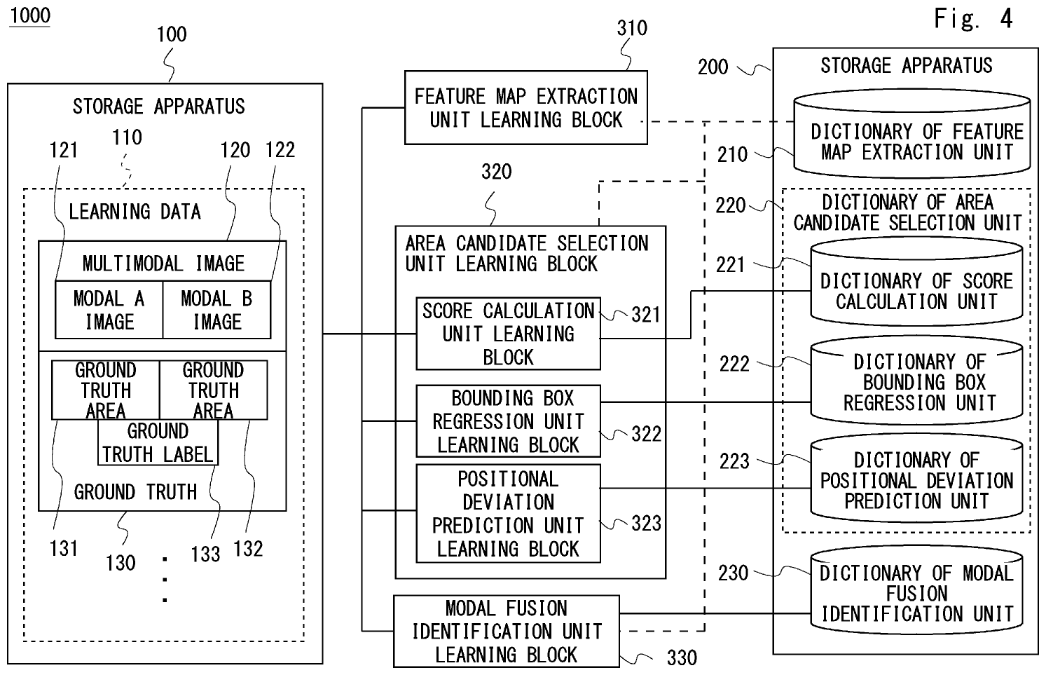

A second example embodiment is one example of the aforementioned first example embodiment. FIG. 4 is a block diagram showing a configuration of an image processing system 1000 according to the second example embodiment. The image processing system 1000 is an information system for learning various parameters used for image recognition processing for performing detection of a specific detection target from multimodal images. The image processing system 1000 may be the one obtained by adding a function to the aforementioned image processing apparatus 1 and specifying the same. Further, the image processing system 1000 may be configured by a plurality of computer apparatuses and achieve each of the functional blocks that will be described later.

The image processing system 1000 at least includes a storage apparatus 100, a storage apparatus 200, a feature map extraction unit learning block 310, an area candidate selection unit learning block 320, and a modal fusion identification unit learning block 330. The area candidate selection unit learning block 320 further includes a score calculation unit learning block 321, a bounding box regression unit learning block 322, and a positional deviation prediction unit learning block 323.

In the at least one computer that composes the image processing system 1000, a processor (not shown) loads a program to a memory (not shown) and executes the loaded program. Thus, since the program is executed, the image processing system 1000 is able to achieve the feature map extraction unit learning block 310, the area candidate selection unit learning block 320, and the modal fusion identification unit learning block 330. The program is a computer program in which learning processing according to this example embodiment described later is implemented. For example, this program is obtained by modifying the aforementioned program 1011. Further, the program may be the one divided into a plurality of program modules or each of the program modules may be executed by one or more computers.

The storage apparatus 100, which is one example of a first storage means, is, for example, a non-volatile storage apparatus such as a hard disk or a flash memory. The storage apparatus 100 stores learning data 110. The learning data 110 is input data used for machine learning in the image processing system 1000. The learning data 110 is a set of data including a plurality of combinations of multimodal image 120 and a ground truth 130. That is, the multimodal image 120 and the ground truth 130 are associated with each other.

The multimodal image 120 is a set of images captured by the plurality of modals. When, for example, the number of modals is two, the multimodal image 120 includes a set of a modal A image 121 and a modal B image 122, and the modal A image 121 and the modal B image 122 are a set of captured images obtained by capturing one target by a plurality of different modals at times close to each other. The type of the modal may be, for example, but not limited thereto, visible light, far-infrared light or the like. The modal A image 121 is, for example, an image captured by a camera A capable of capturing images in an image-capturing mode of a modal A (visible light). Further, the modal B image 122 is an image captured by a camera B capable of capturing images in an image-capturing mode of a modal B (far-infrared light). Therefore, the images of the plurality of modals included in the multimodal image 120 may be the ones captured by the plurality of cameras that correspond to the plurality of respective modals at the same time or at times wherein differences between them are within a few milliseconds of each other. In this case, since there is a difference between the position where the camera A is installed and the position where the camera B is installed, even when one target is captured by these cameras substantially at the same time, this target ends up being captured from different fields of view. Therefore, the positional deviation of the display position of one target ends up occurring between images of the plurality of modals captured by these cameras.

Further, the images of the plurality of modals included in the multimodal image 120 may be images captured by one camera at times close to each other. It is assumed, in this case, that this camera captures images by switching the plurality of modals at predetermined intervals. When, for example, an image of the modal A is a visible image, the image of the modal B may be an image that is captured by the same camera and whose image-capturing time is slightly different from the time when the image of the modal A is captured. It is assumed, for example, that a camera that is used to acquire the image of the modal A and the image of the modal B is the one that employs an RGB frame sequential method like an endoscope. In this case, a focused frame can be regarded as the image of the modal A and the next frame may be regarded as the image of the modal B. That is, the images of the plurality of modals included in the multimodal image 120 may be images of frames that are adjacent to each other, or images that are separated from each other by several frames captured by one camera. When, in particular, the camera is mounted on a mobile body such as a vehicle and captures images outside the vehicle, even the positional deviation between captured images of frames that are adjacent to each other is not negligible. This is because, even when images of one target are successively captured by one camera installed in a fixed position, the distance from the target to the camera or the field of view is changed during the movement. Therefore, the positional deviation of the display position of one target occurs even between images of the plurality of modals captured by different modals by one camera.

Alternatively, the cameras used to acquire the multimodal image 120 may be, for example, optical sensors mounted on satellites different from each other. More specifically, an image from an optical satellite may be regarded as an image of the modal A and an image from a satellite that acquires wide-area temperature information or radio wave information may be regarded as an image of the modal B. In this case, the times at which these satellite images are taken may be the same or may be different from each other.

Further, each of the image data sets of the multimodal image 120 may include images captured by modals of three or more types.

The ground truth 130 includes a ground truth label of a target to be detected included in each of a set of a plurality of images in the multimodal image 120 and each ground truth area which show this target. The ground truth label, which indicates the type of the detection target, is attached to the detection target. Then it is assumed that ground truth areas 131 and 132 in the ground truth 130 are associated with each other to show that they indicate the same target for each of the image data sets in the multimodal image 120. The ground truth 130 may be expressed, for example, by a combination of a ground truth label 133 (the type of the class), the ground truth area 131 of the modal A, and the ground truth area 132 of the modal B. It is assumed, in the example shown in FIG. 4, that the ground truth area 131 is an area including the detection target in the modal A image 121 and the ground truth area 132 is an area including the same detection target in the modal B image 122. The “area” may be expressed, when it has a rectangular shape, by a combination of coordinates (coordinate values of an X axis and a Y axis) of a representative point (center or the like) of an area, the width, and the height or the like. Further, the “area” may not be a rectangular shape and may instead be a mask area that expresses a set of pixels in which the target is shown by a list or an image. Instead of describing the respective ground truth areas of the modal A and the modal B, the difference in the coordinates of the representative point of the respective ground truth areas in the modal A and the modal B may be included in the ground truth as the correct answer value of the positional deviation.

The storage apparatus 200, which is one example of a second storage means and the storage unit 13, is, for example, a non-volatile storage apparatus such as a hard disk or a flash memory. The storage apparatus 200 stores dictionaries 210, 220, and 230. The dictionary 220 further includes dictionaries 221, 222, and 223. Each of the dictionaries 210, etc., which is a set of parameters set in a predetermined processing module (model), is, for example, a database. In particular, the dictionaries 210 etc. are values trained in respective learning blocks that will be described later. Initial values of the parameters may be set in the dictionaries 210 etc. before the learning is started. Further, the details of the dictionaries 210 etc. will be described along with the description of the respective learning blocks that will be given later.

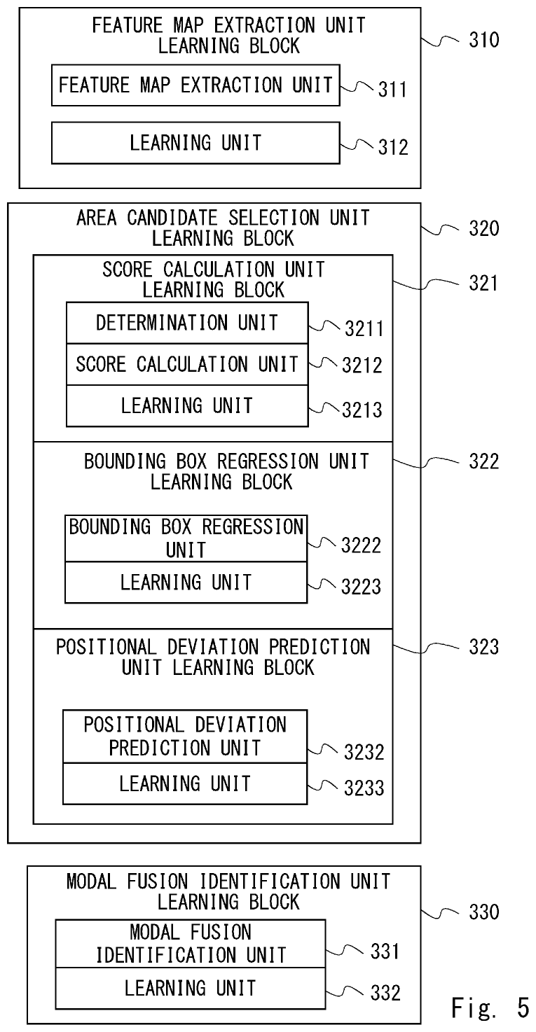

FIG. 5 is a block diagram showing internal configurations of the respective learning blocks according to the second example embodiment. The feature map extraction unit learning block 310 includes a feature map extraction unit 311 and a learning unit 312. The feature map extraction unit 311 is a model calculating (extracting) feature maps indicating information that is useful for detecting an object from each of the modal A image 121 and the modal B image 122 in the multimodal image 120, that is, a processing module. The learning unit 312, which is one example of a fourth learning means, is means for adjusting the parameters of the feature map extraction unit 311. Specifically, the learning unit 312 reads out the parameters stored in the dictionary 210, sets the parameters that have been read out in the feature map extraction unit 311, inputs an image of one modal to the feature map extraction unit 311, and extracts the feature map. That is, it is assumed that the learning unit 312 calculates the feature map using the feature map extraction unit 311 independently for the modal A image 121 and the modal B image 122 in the multimodal image 120.

Then the learning unit 312 adjust (learns) the parameters of the feature map extraction unit 311 in such a way that a loss function calculated using the extracted feature maps becomes small, and updates (stores) the dictionary 210 by the parameters after the adjustment. The loss function used in the above operation may be, for the first time, the one that corresponds to the error of a desired image recognition output temporarily connected. Further, for the second and subsequent times, the parameters are adjusted in a similar way so that the output in the area candidate selection unit learning block 320 or the like that will be described later approaches the ground truth.

When, for example, a model of a neural network is used as the feature map extraction unit 311, there is a method of temporarily adding an identifier that performs image classification from the extracted feature map and updating a weight parameter from a classification error by a back propagation method. The feature map here is information in which results of performing predetermined conversion on each pixel value in an image are arranged in a form of a map that corresponds to the respective positions in the image. In other words, the feature map is a set of data in which the feature amount calculated from a set of pixel values included in a predetermined area in the input image is associated with the positional relation in the image. Further, in the case of the CNN, for example, it is assumed that a calculation that passes a convolution layer, a pooling layer and the like an appropriate number of times from the input image is performed as the processing of the feature map extraction unit 311. In this case, it can be said that the parameter is a value of a filter used in each convolution layer. The output of each convolution layer may include a plurality of feature maps. In this case, the product of the number of images or feature maps input to the convolution layer and the number of feature maps to be output becomes the number of filters to be held.

The dictionary 210 of the feature map extraction unit is a part that holds a set of parameters learned by the feature map extraction unit learning block 310. Then by setting the parameters in the dictionary 210 in the feature map extraction unit 311, a method of extracting the learned feature map can be reproduced. The dictionary 210 may be a dictionary that is independent for each modal. Further, the parameters in the dictionary 210 are one example of a fourth parameter.

The score calculation unit learning block 321 includes a determination unit 3211, a score calculation unit 3212, and a learning unit 3213. The determination unit 3211 is one example of the aforementioned determination unit 11. The score calculation unit 3212 is a model that calculates a score for the area as a priority for selecting the detection candidate area, that is, a processing module. In other words, the score calculation unit 3212 calculates the score that indicates the degree of the detection target for the candidate area using set parameters. The learning unit 3213, which is one example of a second learning means, is means for adjusting the parameters of the score calculation unit 3212. That is, the learning unit 3213 learns the parameters of the score calculation unit 3212 based on the set of the results of the determination by the determination unit 3211 and the feature maps, and stores the learned parameters in the dictionary 221.

Assume a case, for example, a set of predetermined rectangular areas that are common to the modal A and the modal B are defined in advance and are stored in the storage apparatus 100 or the like. The rectangular area is defined by, for example, but not limited thereto, four elements including two coordinates that specify the central position, the width, and the height. In other words, it can be said that the predetermined rectangular area is an area that has a scale or an aspect ratio given in advance and has been arranged for each pixel position on the feature map. Then the determination unit 3211 selects a one rectangular area from the set of predetermined rectangular areas and calculates an Intersection over Union (IoU) between coordinates of the selected rectangular area and each of the ground truth areas 131 and 132 included in the ground truth 130. The IoU, which is a degree of overlapping, is a value obtained by dividing the area of the common part by the merged area. The IoU is also one example of the degree to which the candidate area includes the ground truth area. Further, the IoU makes no distinction even when there are a plurality of detection targets. Then the determination unit 3211 repeats this processing for all the predetermined rectangular areas in the storage apparatus 100. After that, the determination unit 3211 sets predetermined rectangular areas in which the IoU becomes equal to or larger than a constant value (a threshold) as positive examples. Further, the determination unit 3211 sets predetermined rectangular areas in which the IoU becomes smaller than a constant value as negative examples. In this case, the determination unit 3211 may sample a predetermined number of predetermined rectangular areas in which the IoU becomes equal to or larger than the constant value and set them as the positive examples in order to balance between the positive examples and the negative examples. Likewise, the determination unit 3211 may sample a predetermined number of predetermined rectangular areas in which the IoU becomes smaller than the constant value and set them as the negative examples. Further, it can be said that the determination unit 3211 generates, for each of the rectangular areas, a set of the result of the determination of the correctness based on the IoU with the ground truth area 131 that corresponds to the modal A and the result of the determination of the correctness based on the IoU with the ground truth area 132 that corresponds to the modal B.

The learning unit 312 reads out the parameters stored in the dictionary 221, sets the parameters that have been read out in the score calculation unit 3212, and inputs one rectangular area into the score calculation unit 3212 to cause the score calculation unit 3212 to calculate scores. The learning unit 312 adjusts (learns) the parameters in such a way that the scores calculated for the rectangular areas and the modals determined to be the positive examples by the determination unit 3211 become relatively high. Further, the learning unit 312 adjusts (learns) the parameters in such a way that scores calculated for the rectangular areas and the modals determined to be the negative examples by the determination unit 3211 become relatively low. Then the learning unit 312 updates (stores) the dictionary 221 by the parameters after the adjustment.

Further, for example, the learning unit 312 may perform learning of positive/negative binary classification to determine whether or not the predetermined rectangular area sampled from the feature map extracted by the feature map extraction unit 311 using the dictionary 210 of the feature map extraction unit is a detection target. When the model of the neural network is used as the score calculation unit 3212, two outputs that correspond to positive and negative may be prepared and the weight parameter may be determined by a gradient descent method regarding a cross entropy error function. In this case, the parameters of the network are updated in such a way that the value of the element that corresponds to the positive example of the output approaches 1 and the value of the element that corresponds to the negative example of the output approaches 0 in the prediction for the rectangular areas that correspond to the positive examples. Further, the outputs for the respective predetermined rectangular areas may be preferably calculated from the feature maps in the vicinity of the central position of the rectangular areas and arranged in a shape of a map in the same arrangement. Accordingly, the processing by the learning unit 3213 may be expressed as the calculation by the convolution layer. Regarding the shape of the predetermined rectangular areas, a plurality of maps to be output may be prepared in accordance therewith.

The dictionary 221 of the score calculation unit is a part that holds the set of parameters learned by the score calculation unit learning block 321. Then the parameters in the dictionary 221 are set in the score calculation unit 3212, whereby it is possible to reproduce the learned score calculation method. Further, the parameters in the dictionary 221 are one example of a second parameter.

The bounding box regression unit learning block 322 includes a bounding box regression unit 3222 and a learning unit 3223. The bounding box regression unit learning block 322 may further include a processing module that includes a function that corresponds to the aforementioned determination unit 3211. Alternatively, the bounding box regression unit learning block 322 may receive information indicating the set of the results of the determination of the correctness for the predetermined rectangular area from the aforementioned determination unit 3211.

The bounding box regression unit 3222 is a model for returning the conversion to make coordinates of the predetermined rectangular area which serves as a base coincide with the detection target more accurately to predict the detection candidate area, that is, a processing module. In other words, the bounding box regression unit 3222 performs regression to bring the position and the shape of the candidate area close to the ground truth area used to determine the correctness of this candidate area. The learning unit 3223, which is one example of a third learning means, is means for adjusting the parameters of the bounding box regression unit 3222. That is, the learning unit 3223 learns the parameters of the bounding box regression unit 3222 based on the set of the results of the determination by the determination unit 3211 and the feature map and stores the learned parameters in the dictionary 222. However, it is assumed that the information of the rectangular area that the learning unit 3223 outputs as a result of the regression is the position on one modal which serves as a reference, the intermediate position of the modal A and the modal B or the like.

Further, the learning unit 3223 uses the feature map extracted by the feature map extraction unit 311 using the dictionary 210 of the feature map extraction unit for the predetermined rectangular area that corresponds to the positive example determined by a criterion the same as that used in the score calculation unit learning block 321. Then the learning unit 3223 performs learning of the regression using, for example, the conversion of rectangular coordinates into the ground truth area included in the ground truth 130 for one of the modals as a correct answer.

When the model of the neural network is used as the bounding box regression unit 3222, the outputs for the respective predetermined rectangular areas may be preferably calculated from the feature map in the vicinity of the central position of the corresponding rectangular area and arranged in a shape of a map in the same arrangement. Accordingly, the processing by the learning unit 3223 may be expressed as the calculation by the convolution layer. Regarding the shape of the predetermined rectangular area, a plurality of maps to be output may be prepared in accordance therewith.

Further, regarding the difference between the coordinates indicating the area and the ground truth area, the weight parameter may be determined by a gradient descent method related to a smooth L1 loss function or the like.

The dictionary 222 of the bounding box regression unit is a part that holds a set of parameters learned by the bounding box regression unit learning block 322. Then the parameters in the dictionary 222 are set in the bounding box regression unit 3222, whereby it is possible to reproduce the learned bounding box regression method. The parameters in the dictionary 222 are one example of a third parameter.

The positional deviation prediction unit learning block 323 includes a positional deviation prediction unit 3232 and a learning unit 3233. The positional deviation prediction unit learning block 323 may further include a processing module that includes a function that corresponds to the aforementioned determination unit 3211. Alternatively, the positional deviation prediction unit learning block 323 may receive information indicating the set of the results of the determination of the correctness for the predetermined rectangular area from the aforementioned determination unit 3211.

The positional deviation prediction unit 3232 is a model that predicts the positional deviation between modals for an input area including the detection target, that is, a processing module. In other words, the positional deviation prediction unit 3232 predicts the amount of positional deviation between modals in a ground truth label. The learning unit 3233, which is one example of a first learning means, is means for adjusting the parameters of the positional deviation prediction unit 3232. That is, the learning unit 3233 learns the parameters of the positional deviation prediction unit 3232 using the difference between each of the plurality of ground truth areas in the set of the results of the determination in which the degree to which the candidate area includes the ground truth area is equal to or larger than a predetermined value and the predetermined reference area in the detection target as the amount of positional deviation. The learning unit 3233 may use one of the plurality of ground truth areas or an intermediate position of the plurality of ground truth areas as a reference area. The learning unit 3223 included in the bounding box regression unit learning block 322 may also define the reference area in a similar way. Then the learning unit 3233 stores the learned parameters in the dictionary 223.

Further, the learning unit 3233 uses the feature map obtained using the dictionary 210 of the feature map extraction unit for the predetermined rectangular area which is regarded to be the positive example in the score calculation unit learning block 321. Then the learning unit 3233 adjusts the parameter so as to cause the positional deviation prediction unit 3232 to predict the amount of positional deviation using, for example, the amount of positional deviation between the corresponding ground truth areas as a correct answer in accordance with the ground truth 130. That is, the learning unit 3233 learns the parameters using the plurality of feature maps extracted by the feature map extraction unit 311 using the parameters stored in the dictionary 210.

In other words, first, the learning unit 3233 reads out the parameters stored in the dictionary 223 and sets the parameters that have been read out in the positional deviation prediction unit 3232. Then the learning unit 3233 adjusts (learns) the parameters in such a way that the difference between the ground truth area of the candidate area of the positive example and the predetermined reference area in the detection target of the ground truth area is set as the amount of positional deviation. When, for example, one ground truth area is a reference area, the difference between the ground truth area and the other ground truth area is set as the amount of positional deviation. Further, when the intermediate position of the respective ground truth areas is set as the reference area, a double of the difference between at least one ground truth area and the reference area becomes the amount of positional deviation. Then the learning unit 3233 updates (stores) the dictionary 223 by the parameters after the adjustment.

Further, when an objective variable is adjusted to the area of the modal which serves as a reference in the bounding box regression unit learning block 322, how an area in another modal is relatively deviated may be set as the correct answer of the amount of positional deviation. When the model of the neural network is used as the positional deviation prediction unit 3232, the amounts of positional deviation may be calculated from feature maps in the vicinity of the central position of the corresponding predetermined rectangular area and may be arranged in the form of a map in the same arrangement. Accordingly, processing by the learning unit 3233 may be expressed as the calculation by the convolution layer. Regarding the shape of the predetermined rectangular area, a plurality of maps to be output may be prepared in accordance therewith. Further, the gradient descent method regarding the smooth L1 loss function of the amount of positional deviation can be selected for the update of the weight parameter. Another possible method may be a method of measuring the similarity. However, if there is a parameter included in the calculation of the similarity, it can be determined by a cross validation or the like.

The form of the positional deviation to be predicted may be selected in accordance with characteristics of cameras that are installed. When, for example, the camera A that captures the modal A image 121 and the camera B that captures the modal B image 122 that form an image data set in the multimodal image 120 are aligned side by side to each other, prediction limited only to a parallel translation in the horizontal direction may be learned.

The dictionary 223 of the positional deviation prediction unit is a part that holds a set of parameters learned by the positional deviation prediction unit learning block 323. By setting the parameters in the dictionary 223 in the positional deviation prediction unit 3232, the method for predicting the positional deviation between modals that has been learned can be reproduced. Further, the parameters in the dictionary 223 are one example of a first parameter.

The modal fusion identification unit learning block 330 includes a modal fusion identification unit 331 and a learning unit 332. The modal fusion identification unit 331 is a model for performing fusion to the feature maps of all the modals and identifying the detection candidate area to thereby guiding the result of the detection based on the feature maps of the respective modals, that is, a processing module. The learning unit 332, which is one example of a fifth learning means, is means for adjusting the parameters of the modal fusion identification unit 331. For example, the learning unit 332 receives, for the detection candidate area calculated by the area candidate selection unit learning block 320, the one obtained by cutting out the feature map extracted by the feature map extraction unit 311 for each modal using the dictionary 210 of the feature map extraction unit. Then the learning unit 332 causes the modal fusion identification unit 331 to perform modal fusion and identification of the detection candidate area for the above input. In this case, the learning unit 332 adjusts (learns) the parameters of the modal fusion identification unit 331 so that the class of the detection target and the area position indicated by the ground truth 130 are predicted. Then the learning unit 332 updates (stores) the dictionary 230 by the parameters after the adjustment.

In a case in which the model of the neural network is used as the modal fusion identification unit 331, a feature in which the feature map of each model that has been cut out is fused by a convolution layer or the like may be calculated and identification may be performed in fully connected layers using this feature. Further, the learning unit 332 determines the weight of the network by a cross-entropy loss for class classification and by a gradient descent method related to a smooth L1 loss function or the like of a conversion parameter of coordinates for adjustment of the detection area. However, a decision tree or a support vector machine may be used as the identification function.

The dictionary 230 of the modal fusion identification unit is a part that holds a set of parameters learned by the modal fusion identification unit learning block 330. Then the parameters in the dictionary 230 are set in the modal fusion identification unit 331, whereby it is possible to reproduce the method of modal fusion and identification that has been learned. Further, the parameters in the dictionary 230 are one example of a fifth parameter.

While the dictionary 220 of the area candidate selection unit is divided into 221 to 223 depending on the functions in FIG. 4, there may be a common part as well. Further, while the model of the learning target (the feature map extraction unit 311 or the like) is described inside each learning block in FIG. 5, they may be present outside the area candidate selection unit learning block 320. For example, the model of the learning target may be a library stored in the storage apparatus 200 or the like, and invoked and executed by each learning block. Further, the score calculation unit 3212, the bounding box regression unit 3222, and the positional deviation prediction unit 3232 may be collectively referred to as an area candidate selection unit.

When a neural network is used as each part (model) of the learning target, a weight parameter of a network is stored in the dictionaries 210, 220, and 230, and, as the learning blocks 310, 320, and 330, a gradient descent method regarding the respective error functions is used. In the neural network, the gradient of the error function may be calculated for an upstream part as well. Therefore, as shown by the dashed lines in FIG. 4, the dictionary 210 of the feature map extraction unit can be updated by the area candidate selection unit learning block 320 or the modal fusion identification unit learning block 330.

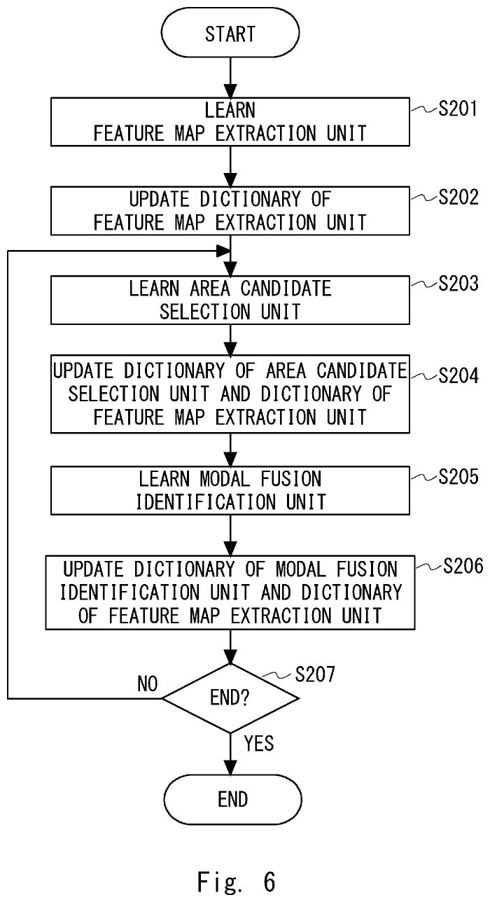

FIG. 6 is a flowchart for describing a flow of learning processing according to the second example embodiment. First, the learning unit 312 of the feature map extraction unit learning block 310 learns the feature map extraction unit 311 (S201). It is assumed, at this moment, that desired initial parameters are stored in the dictionary 210 and a ground truth data of a desired feature map is input to the learning unit 312. Next, the learning unit 312 reflects (updates) the parameters of the results in Step S201 in the dictionary 210 of the feature map extraction unit (S202). Next, the area candidate selection unit learning block 320 learns the area candidate selection unit using the feature map extracted using the updated dictionary 210 (S203). That is, in the score calculation unit learning block 321, the learning unit 3213 learns the score calculation unit 3212 based on the result of the determination made in the determination unit 3211. Further, in the bounding box regression unit learning block 322, the learning unit 3223 learns the bounding box regression unit 3222 based on the result of the determination made in the determination unit 3211. Further, in the positional deviation prediction unit learning block 323, the learning unit 3233 learns the positional deviation prediction unit 3232 based on the result of the determination made in the determination unit 3211. Then the area candidate selection unit learning block 320 reflects (updates) the parameters of the results in Step S203 in the dictionary 220 of the area candidate selection unit, that is, the dictionaries 221-223 (S204). However, when a neural network is used, the area candidate selection unit learning block 320 concurrently updates the dictionary 210 of the feature map extraction unit. Specifically, the area candidate selection unit learning block 320 calculates the gradient regarding the weight parameter of each loss function in the learning blocks 321-323 also for the parameters in the feature map extraction unit 311 and performs the update based on the gradient. After that, the learning unit 332 of the modal fusion identification unit learning block 330 learns the modal fusion identification unit 331 (S205). At this time, the learning unit 332 uses the feature map obtained using the dictionary 210 of the feature map extraction unit in the detection candidate areas obtained using the dictionaries 221-223 of the area candidate selection unit. Then the learning unit 332 reflects (updates) the parameters of the results in Step S205 in the dictionary 230 of the modal fusion identification unit (S206). However, when a neural network is used, the learning unit 332 concurrently updates the dictionary 210 of the feature map extraction unit. Specifically, the learning unit 332 calculates the gradient regarding the parameters of the loss function in the learning block 330 also for the parameters of the feature map extraction unit 311, and performs the update based on the gradient. After that, the image processing system 1000 determines whether or not the processing from Steps S203 to S206 has been repeated a predetermined number of times set in advance, that is, whether or not a condition for ending the processing is satisfied (S207). When the number of times of the processing is smaller than a predetermined number of times (NO in S207), the process goes back again to Step S203 since the condition for the prediction of the detection candidate area has been changed. Then Steps S203 to S206 are repeated until the respective parameters are sufficiently optimized. When the above processing has been repeated a predetermined number of times in Step S207 (YES in S207), this learning processing is ended. In the final learning of the repetition of the processing, the dictionary of the feature map extraction unit in Step S206 may not be updated and the parameters may be fixed.

Regarding the repeating processing from Steps S203 to S207 in

FIG. 6, other processing may be employed. For example, the following processing may be employed. First, after Steps S203 and S204, S203 is executed in parallel to Step S205 (S208). Then the learning of the feature map extraction unit learning block 310 is performed in consideration of both the learning by the modal fusion identification unit learning block 330 and the learning by the area candidate selection unit learning block 320 (S209). After that, the dictionaries 210, 220, and 230 are updated in accordance with the results of the learning (S210). When the dictionary 210 of the feature map extraction unit has been updated, Steps S208, S209, and S210 are performed again. When the dictionary 210 of the feature map extraction unit has not been updated in Step S210, this learning processing is ended.

As described above, the image processing system 1000 according to this example embodiment learns the model in the area candidate selection unit learning block 320 using the ground truth areas 131 and 132 that correspond to the modal A image 121 and the modal B image 122, respectively, in the multimodal image 120. In particular, the positional deviation prediction unit learning block 323 in the area candidate selection unit learning block 320 learns the parameters of the positional deviation prediction unit 3232 that predicts the amount of positional deviation between modals in a specific ground truth label. Accordingly, it is possible to calculate the accurate detection candidate area for each modal in accordance with the positional deviation between the input images.

Further, in this example embodiment, the parameters of the score calculation unit and the bounding box regression unit are learned using a set of ground truth areas in which the positional deviation is taken into account, the set of ground truth areas corresponding to the respective modals. Therefore, the calculation of scores and the bounding box regression that reflect the positional deviation can be performed and the accuracies thereof may be improved compared to Non-Patent Literature 1.

Furthermore, in this example embodiment, the parameters of the feature map extraction unit are learned using the set of the results of the determination regarding the correctness of the rectangular area by the aforementioned set of the ground truth areas, the feature map is extracted again using the parameters after the learning, and then various parameters of the area candidate selection unit are learned. Accordingly, it is possible to further improve the accuracy of the area candidates to be selected.

Further, the parameters of the modal fusion identification unit are learned using the extracted feature map, as described above. Accordingly, it is possible to improve the accuracy of the processing of the modal fusion identification unit.

Further, according to this example embodiment, it is possible to improve the performance of the object detection. This is because while positional deviation in the image due to the parallax depends on the distance from the light receiving surface, this positional deviation in the image can be approximated by a parallel translation for each area mainly including only the same object. Then by dividing the detection candidate areas for each modal, detection candidate areas moved by the amount corresponding to the predicted positional deviation can be combined with each other, whereby the image can be recognized from a set of feature maps substantially the same as that in the case in which there is no positional deviation. It is further possible to obtain a recognition method for a detection candidate area in which the positional deviation is corrected at the time of learning, which also helps improving the performance of the object detection.

### Third Example Embodiment

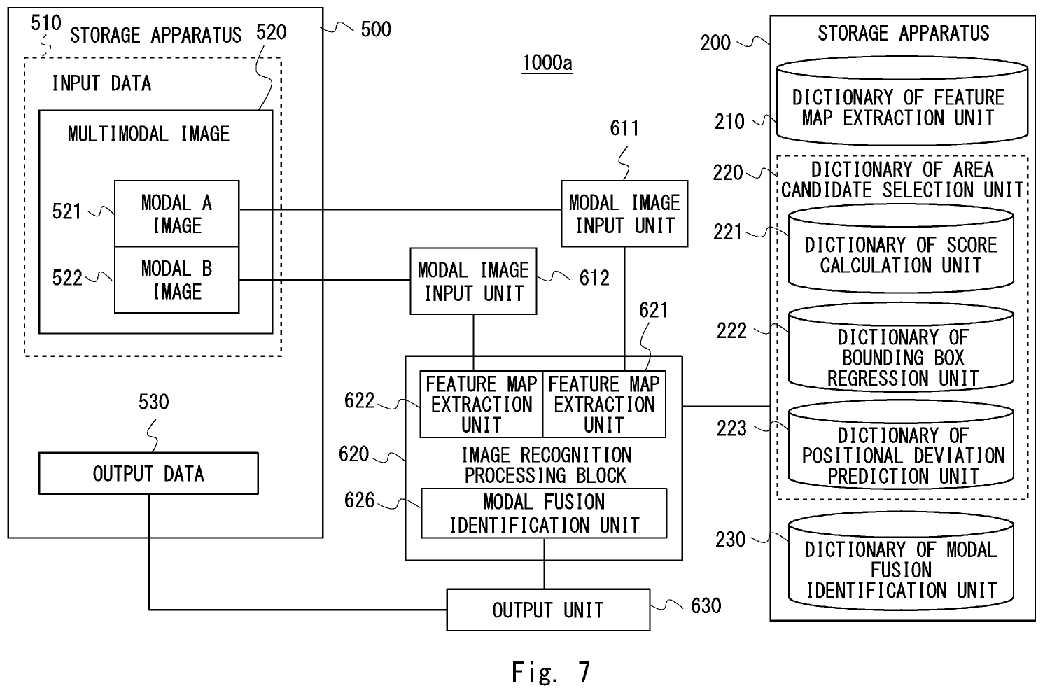

A third example embodiment is an application example of the aforementioned second example embodiment. This third example embodiment performs image recognition processing for performing object detection from a desired multimodal image using the respective parameters learned by the image processing system 1000 according to the second example embodiment. FIG. 7 is a block diagram showing a configuration of an image processing system 1000a according to the third example embodiment. The image processing system 1000a is the one obtained by adding functions to the image processing system 1000 in FIG. 4 and configurations other than the storage apparatus 200 shown in FIG. 4 are omitted in FIG. 7. Therefore, the image processing system 1000a may be the one obtained by adding the functions to the aforementioned image processing apparatus 1 and specifying the same. Further, the image processing system 1000a may be composed of a plurality of computer apparatuses and achieve each of the functional blocks that will be described later.

The image processing system 1000a at least includes a storage apparatus 500, a storage apparatus 200, modal image input units 611 and 612, an image recognition processing block 620, and an output unit 630. Further, the image recognition processing block 620 at least includes feature map extraction units 621 and 622 and a modal fusion identification unit 626.

In at least one computer that composes the image processing system 1000a, a processor (not shown) loads a program in a memory (not shown) and executes the program that has been loaded. Accordingly, in the image processing system 1000a, this program is executed, whereby it is possible to achieve the modal image input units 611 and 612, the image recognition processing block 620, and the output unit 630. This program is a computer program in which the image recognition processing that will be described later according to this example embodiment is implemented in addition to the aforementioned learning processing. For example, this program is obtained by modifying the program according to the aforementioned second example embodiment. Further, this program may be divided into a plurality of program modules and each program module may be executed by one or more computers.

The storage apparatus 500 is, for example, a non-volatile storage apparatus such as a hard disk or a flash memory. The storage apparatus 500 stores input data 510 and output data 530. The input data 510 is information including a multimodal image 520 which is to be recognized. The input data 510 may include a plurality of multimodal images 520. The multimodal image 520 is a set of a modal A image 521 and a modal B image 522 captured by a plurality of different modals, like the aforementioned multimodal image 120. For example, it is assumed that the modal A image 521 is an image captured by the modal A and the modal B image 522 is an image captured by the modal B. The output data 530 is information indicating the results of the image recognition processing for the input data 510. For example, the output data 530 includes an area and a label identified as a detection target, a score indicating the probability as the detection target and the like.

The storage apparatus 200 has a configuration similar to that shown in FIG. 4, and in particular, stores the parameter after the learning processing in FIG. 6 is ended.

The modal image input units 611 and 612 are processing modules for reading out the modal A image 521 and the modal B image 522 from the storage apparatus 500 and outputting the images that have been read out to the image recognition processing block 620. Specifically, the modal image input unit 611 receives the modal A image 521 and outputs the modal image A 521 to the feature map extraction unit 621. Further, the modal image input unit 612 receives the modal B image 522 and outputs the modal B image 522 to the feature map extraction unit 622.

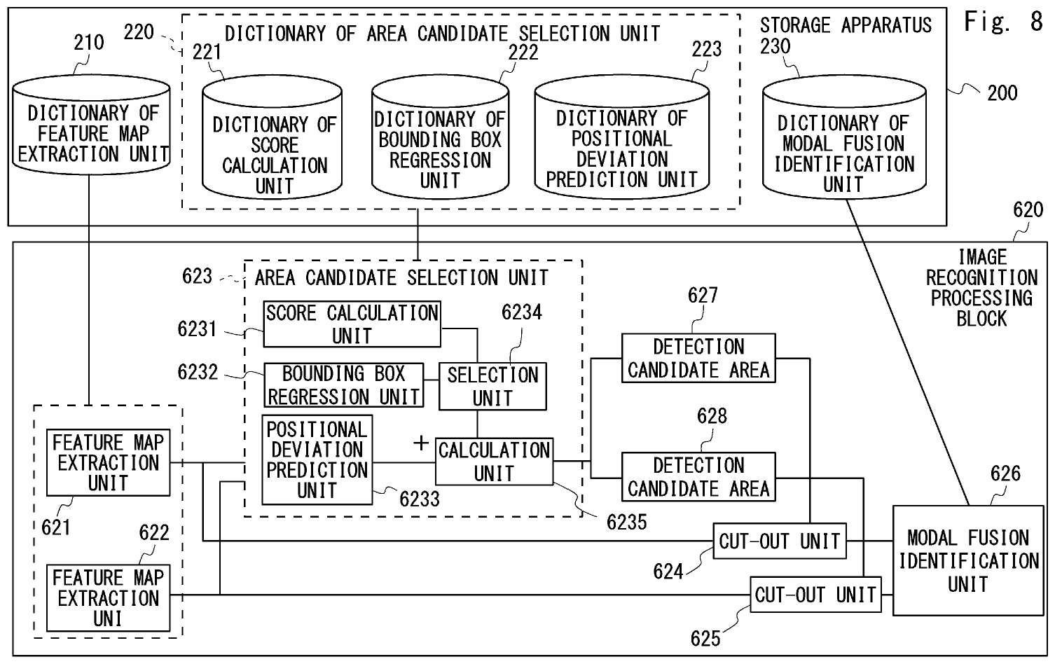

FIG. 8 is a block diagram showing an internal configuration of an image recognition processing block 620 according to the third example embodiment. The storage apparatus 200 is similar to that shown in FIG. 7. The image recognition processing block 620 includes feature map extraction units 621 and 622, an area candidate selection unit 623, cut-out units 624 and 625, and a modal fusion identification unit 626. Further, detection candidate areas 627 and 628 shown as the internal configuration of the image recognition processing block 620, which are shown for the sake of convenience of the description, are intermediate data in the image recognition processing. Therefore, the detection candidate areas 627 and 628 are substantially present in a memory in the image processing system 1000a.

The feature map extraction units 621 and 622 are processing modules including functions that are equal to those of the aforementioned feature map extraction unit 311. For example, a local feature extractor such as a convolutional neural network or Histograms of Oriented Gradients (HOG) features can be applied. Further, the feature map extraction units 621 and 622 may use a library that is the same as that in the feature map extraction unit 311. The feature map extraction units 621 and 622 set the parameters stored in the dictionary 210 in the internal model formula or the like. For example, a controller (not shown) in the image recognition processing block 620 may read out various parameters in the dictionary 210 from the storage apparatus 200 and give the parameters as arguments when the feature map extraction units 621 and 622 are invoked.

Then the feature map extraction unit 621 extracts the feature map (of the modal A) from the modal A image 521 input from the modal image input unit 611 by a model formula in which the above parameters have been set. The feature map extraction unit 621 outputs the extracted feature map to the area candidate selection unit 623 and the cut-out unit 624. Likewise, the feature map extraction unit 622 extracts the feature map (of the modal B) from the modal B image 522 input from the modal image input unit 612 by the model formula in which the above parameters have been set. The feature map extraction unit 622 outputs the extracted feature map to the area candidate selection unit 623 and the cut-out unit 625.

The area candidate selection unit 623 receives the feature maps of the respective modals from the feature map extraction units 621 and 622 and selects a set of detection candidate areas that correspond to the respective modals from among the plurality of predetermined rectangular areas in consideration of the positional deviation between the modals. Then the area candidate selection unit 623 outputs the selected set of detection candidate areas to the cut-out units 624 and 625. As described above, the freedom of the rectangular area is four, namely, two coordinates that specify the central position, the width, and the height. Therefore, if it is assumed that the scale is not changed between the modals, it is sufficient that the area candidate selection unit 623 output only the coordinates of the central position by the number corresponding to the number of modals. Note that a plurality of set of detection candidate areas may be output. The area candidate selection unit 623 is a processing module including a score calculation unit 6231, a bounding box regression unit 6232, a positional deviation prediction unit 6233, a selection unit 6234, and a calculation unit 6235.

The score calculation unit 6231 calculates the score that individually evaluates the likelihood of being the detection target for the feature maps of the respective modals to be input. The bounding box regression unit 6232 predicts a more appropriate position, the width, and the height for each of the predetermined rectangular areas. The positional deviation prediction unit 6233 predicts the amount of positional deviation for alignment between the modals. The selection unit 6234 selects the detection candidate area from among a plurality of areas after regression based on the scores of the score calculation unit 6231 and the results of regression of the bounding box regression unit 6232. The calculation unit 6235 calculates the area of another modal that corresponds to the detection candidate area selected by the selection unit 6234 from the amount of positional deviation predicted by the positional deviation prediction unit 6233.

The score calculation unit 6231, the bounding box regression unit 6232, and the positional deviation prediction unit 6233 are processing modules having functions that are similar to those of the aforementioned score calculation unit 3212, bounding box regression unit 3222, and positional deviation prediction unit 3232. Therefore, the score calculation unit 6231, the bounding box regression unit 6232, and the positional deviation prediction unit 6233 may use a library that is the same as the library of the aforementioned score calculation unit 3212, the bounding box regression unit 3222, and the positional deviation prediction unit 3232. The score calculation unit 6231 sets the parameters stored in the dictionary 221 in the internal model formula or the like. Likewise, the bounding box regression unit 6232 sets the parameters stored in the dictionary 222 in the internal model formula or the like. Further, the positional deviation prediction unit 6233 sets the parameters stored in the dictionary 223 in the internal model formula or the like. When, for example, the aforementioned controller reads out various parameters in the dictionary 220 from the storage apparatus 200 to invoke the score calculation unit 6231, the bounding box regression unit 6232, and the positional deviation prediction unit 6233, the corresponding parameters may be given thereto as arguments.

The score calculation unit 6231 calculates the score of the reliability of the likelihood of being the detection target using the dictionary 221 of the score calculation unit in order to narrow down the detection candidate area from among all the predetermined rectangular areas in the image. However, the score calculation unit 6231 receives all the feature maps extracted by the feature map extraction units 621 and 622. Then the score calculation unit 6231 predicts whether the area is the detection target or not from the information of both the modal A and the modal B. However, in the aforementioned learning stage, the parameters of the score calculation unit 6231 are learned so as to calculate the score with which it can be regarded that the area is the detection target when the degree of overlapping of the corresponding predetermined rectangular area and the ground truth area exceeds a threshold given in advance. In a case in which the neural network is used, by using the convolution layer, the output for each pixel position on the feature map can be provided. Therefore, the parameters of the score calculation unit 6231 may be learned in such a way that each of them performs binary classification to determine whether or not the area is the detection target.

The bounding box regression unit 6232 is a processing module that predicts, for a target predetermined rectangular area, rectangular coordinates that surround the detection target more accurately on the modal A, which is a reference, using the dictionary 222 of the bounding box regression unit. The predetermined rectangular area targeted by the bounding box regression unit 6232 is such an area that the degree of overlapping with one ground truth area exceeds a threshold given in advance. For example, the bounding box regression unit 6232 may target the rectangular area in which a score equal to or larger than a predetermined value has been calculated in the score calculation unit 6231. Further, in the case in which the neural network is used, the output for each pixel position on the feature map may be provided when a convolution layer is used. Therefore, the parameters of the bounding box regression unit 6232 may learn the regression in such a way that the output in each pixel that corresponds to the predetermined rectangular area with sufficient overlap with the ground truth area becomes the difference between the coordinates of the predetermined rectangular area and the coordinates of the ground truth area at the aforementioned learning stage. Accordingly, the rectangular coordinates that are desired to be obtained can be obtained by converting the coordinates of the predetermined rectangular area by the predicted difference.

The positional deviation prediction unit 6233 is a processing module that predicts the amount of positional deviation of the modal B with respect to the modal A using the dictionary 223 of the positional deviation prediction unit. As a method of achieving the above, the positional deviation prediction unit 6233 may acquire the amount of positional deviation through learning from data using a neural network. Further, the following policy for comparing spatial structures may also be, for example, employed. First, the positional deviation prediction unit 6233 extracts an area that corresponds to the predetermined rectangular area from the feature map of the modal A as a patch, and creates a correlation score map of this patch and the whole feature map of the modal B. Then the positional deviation prediction unit 6233 may select the amount of positional deviation that corresponds to the coordinates in the maximum value, assuming that it is highly likely that a deviation of the correlation score to a high position is occurring. Further, a target value of the coordinates may be taken, assuming that a correlation score is the probability. An index such as the one disclosed in Non-Patent Literature 4 in which the application between the original images can be assumed may be, for example, used as the correlation score map. Alternatively, a map in which the matching is preliminary learned by a model such as a neural network may be applied and obtained.

The selection unit 6234 is a processing module that selects the area having a higher priority order with respect to the score for each predetermined rectangular area calculated in the score calculation unit 6231 as a rectangular area that should be left. The selection unit 6234 may perform processing of selecting, for example, a predetermined number of rectangular areas in a descending order of the score.

The calculation unit 6235 is a processing module that calculates a set of detection candidate areas 627 and 628 from the results of regression for the predetermined rectangular area selected by the selection unit 6234 and the amount of positional deviation predicted by the positional deviation prediction unit 6233. Specifically, the rectangular coordinates that surround the detection target when seen in the modal B can be obtained by adding the amount of positional deviation predicted by the positional deviation prediction unit 6233 to the positional coordinates of the output of the bounding box regression unit 6232. Therefore, the calculation unit 6235 outputs the positional coordinates of the area of the results of regression of the rectangular area that has been selected as the detection candidate area 627. Further, the calculation unit 6235 adds the amount of positional deviation to the positional coordinates of the detection candidate area 627 that corresponds to the modal A, thereby calculating the positional coordinates of the detection candidate area 628 that corresponds to the modal B and outputting the positional coordinates as the detection candidate area 628. For example, the calculation unit 6235 outputs the detection candidate area 627 that corresponds to the modal A to the cut-out unit 624 and outputs the detection candidate area 628 that corresponds to the modal B to the cut-out unit 625.

The cut-out units 624 and 625 are processing modules that perform the same processing, cut out the feature amount that corresponds to the input detection candidate area from the input feature map, and shape the feature amount that has been cut out. Specifically, the cut-out unit 624 accepts the inputs of the feature map extracted from the modal A image 521 from the feature map extraction unit 621 and the detection candidate area 627 of the modal A from the calculation unit 6235. Then the cut-out unit 624 cuts out the feature amount of the position that corresponds to the detection candidate area 627 from the feature map of the modal A that has been accepted, that is, the subset of the feature map, shapes the feature amount that has been cut out, and outputs the shaped feature amount to the modal fusion identification unit 626. Likewise, the cut-out unit 625 accepts the inputs of the feature map extracted from the modal B image 522 from the feature map extraction unit 622 and the detection candidate area 628 of the modal B from the calculation unit 6235. Then the cut-out unit 625 cuts out the feature amount of the position that corresponds to the detection candidate area 628 from the feature map of the accepted modal B, that is, the subset of the feature map, shapes the feature amount that has been cut out, and outputs the shaped feature amount to the modal fusion identification unit 626. However, the coordinates of the detection candidate area may not be indicated by the unit of pixels. When the coordinates are not indicated by the unit of pixels, they are converted into values of coordinate positions by a method such as interpolation.

The modal fusion identification unit 626 is a processing module that includes a function that is similar to that of the aforementioned modal fusion identification unit 331 and that performs modal fusion and identification based on a set of subsets of the feature map that corresponds to the position of the detection candidate area. Further, the modal fusion identification unit 626 may use a library that is similar to that of the modal fusion identification unit 331. The modal fusion identification unit 626 sets the parameters stored in the dictionary 230 in the internal model formula or the like. For example, a controller (not shown) in the image recognition processing block 620 may read out various parameters in the dictionary 230 from the storage apparatus 200 and the parameters may be given as arguments when the modal fusion identification unit 626 is invoked.

The modal fusion identification unit 626 accepts the set of subsets of the feature maps that have been cut out by the cut-out units 624 and 625 and calculates, for each of them, the class (label) and the area in which the object is shown. In this case, the modal fusion identification unit 626 uses a model formula in which the aforementioned parameter has been set. Since the positional deviation of the set of feature maps which will be subjected to the modal fusion has been corrected (taken into account) in the modal fusion identification unit 626, the points that both capture the same target can be fused, unlike Non-Patent Literature 1. Further, the modal fusion identification unit 626 predicts, for the information after the fusion, the class indicating which one of the plurality of detection targets it belongs or whether it is a non-detection target, and sets the results of the prediction as the results of the identification. The modal fusion identification unit 626 predicts, for example, for the area in which the object is shown, rectangular coordinates, a mask image or the like. Further, when, for example, a neural network is used, a convolution layer having a filter size 1 or the like may be used for the modal function, and fully connected layers, a convolution layer, global average pooling and the like may be used for the identification. After that, the modal fusion identification unit 626 outputs the results of the identification to the output unit 630.

Referring is made once again to FIG. 7 and the descriptions will be continued. The output unit 630 is a processing module that outputs the results predicted in the modal fusion identification unit 626 to the storage apparatus 500 as the output data 530. In this example, the output unit 630 may generate, besides the result of the detection, an image having a higher visibility from the modal A image and the modal B image, and output the generated image along with the result of the detection. Further, as a method of generating an image having a higher visibility, a desired image may be generated using the method disclosed in, for example, Non-Patent Literature 2 or 3.

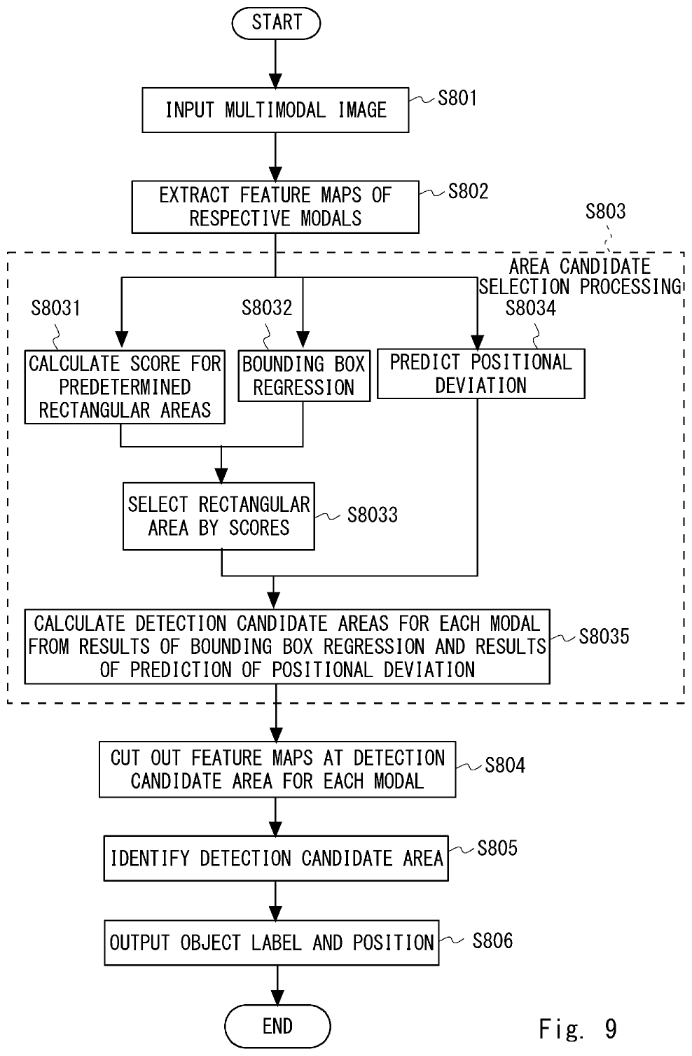

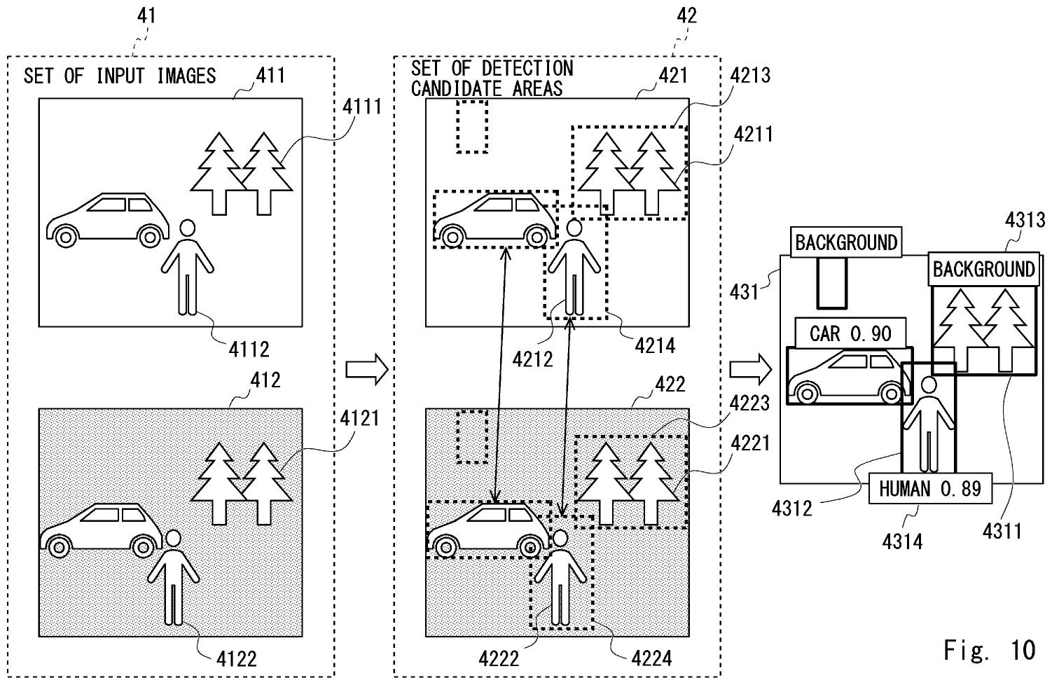

FIG. 9 is a flowchart for describing a flow of object detection processing including the image recognition processing according to the third example embodiment. Further, FIG. 10 is a diagram for describing the concept of the object detection according to the third example embodiment. In the following description, the example shown in FIG. 10 is referred to as appropriate in the description of the object detection processing.

First, the modal image input units 611 and 612 receive the multimodal image 520 that shows the presence or the absence of the detection target and the scene it is desired to investigate (S801). The multimodal image 520 is a set of input images 41 in FIG. 10. The set of input images 41 is a set of an input image 411 captured by the modal A and an input image 412 captured by the modal B. The set of input images 41 may be a set of two (or more) images whose characteristics are different from each other. In the example shown in FIG. 10, the input image 411 includes a background object 4111 that should be regarded as a backdrop and a person 4112, who is a detection target. Further, the input image 412 of another modal includes a background object 4121 that corresponds to the background object 4111 and a person 4122 who corresponds to the person 4112. It is assumed that the camera that has captured the input image 411 and the camera that has captured the input image 412 have such a positional relation that they are arranged horizontally and there is a parallax between them. Therefore, it is assumed that the persons 4112 and 4122 relatively close from the respective cameras in an image are shown to be deviated from each other in the lateral direction. On the other hand, it is assumed that the background objects 4111 and 4121 shown relatively far from the respective cameras in the image are shown at substantially the same position in the image (positions where the parallax can be ignored).

Next, the feature map extraction units 621 and 622 extract the respective feature maps from the input images of the respective modals input in Step S801 (S802).

Next, the area candidate selection unit 623 performs area candidate selection processing for calculating a set of detection candidate areas whose positions in the image may different for each modal from the feature maps for the respective modals (S803). The example shown in FIG. 10 shows, for the input image 411 that corresponds to the modal A and the input image 412 that corresponds to the modal B, that a plurality of pairs of detection candidate areas 42 as shown by the dashed lines in images 421 and 422 are obtained. A detection candidate area 4213 in the image 421 that corresponds to the modal A surrounds a background object 4211 that is the same as the background object 4111. On the other hand, a detection candidate area 4223 in the image 422 that corresponds to the modal B is an area that surrounds a background object 4221 that is the same as the background object 4121 that corresponds to the background object 4111 and forms a pair with the detection candidate area 4213. Then the persons 4112 and 4122 where there is a positional deviation between the input images 411 and 412 by the parallax correspond to persons 4212 and 4222 in the images 421 and 422. Then the person 4212 in the image 421 is surrounded by a detection candidate area 4214 and the person 4222 in the image 422 is surrounded by a detection candidate area 4224. Then the positional deviation is taken into account in the detection candidate area 4214 that corresponds to the modal A and the detection candidate area 4224 that corresponds to the modal B. That is, the positional deviation between the modals A and B is reflected in the set of detection candidate areas 4214 and 4224. In this way, in Step S803, the set of detection candidate areas whose positions are deviated from each other is output. In the following, detailed processing (S8031 to S8035) will be described.

First, the score calculation unit 6231 calculates the scores for the respective predetermined rectangular areas (S8031). Further, the bounding box regression unit 6232 obtains the priority order between the rectangular areas using the scores, which are the output of the score calculation unit 6231, and predicts the rectangular coordinates that surround the detection target more accurately when seen by the modal (A in this example), which serves as a reference (S8032). Further, the positional deviation prediction unit 6233 predicts the amount of positional deviation of the modal B with respect to the modal A (S8034). Steps S8031, S8032, and S8034 may be processed in parallel to one another.

After Steps S8031 and S8032, the selection unit 6234 selects the predetermined rectangular area that should be left based on the scores calculated in Step S8031 (S8033).

After Steps S8033 and S8034, the calculation unit 6235 calculates the set of detection candidate areas for each modal from the results of the bounding box regression for the rectangular area selected in Step S8033 and the results of the prediction of the positional deviation in Step S8034 (S8035).

After that, the cut-out units 624 and 625 cut out the feature maps from the respective feature maps extracted in Step S802 at positional coordinates of the detection candidate area calculated in Step S8035 (S804). Then the modal fusion identification unit 626 fuses the modals of the set of subsets of the feature maps that have been cut out and identifies the class (label) (S805).

Lastly, the output unit 630 outputs, as the results of the identification, which class each of the respective detection candidate areas belongs to, namely, whether it is one of the detection targets or the background, and the area on the image in which it is shown (S806). The results of the identification can be displayed, for example, as shown in the output image 431 in FIG. 10. In this example, it is assumed that the modal A of the input image 411 is regarded to be a reference or for a display. Then the output image 431 indicates that the results of the identification of the detection candidate areas 4213 and 4223 are aggregated in the upper detection candidate area 4311 and that the results of the identification of the detection candidate areas 4214 and 4224 are aggregated in the lower detection candidate area 4312. A label 4313 indicating a backdrop is attached to the detection candidate area 4311 as results of the identification and a label 4314 indicating a person is attached to the detection candidate area 4312 as the results of the identification.

It can be said that this example embodiment further includes the candidate area selection unit added to the image processing apparatus or the system according to the aforementioned example embodiments. The candidate area selection unit predicts the amount of positional deviation in the detection target between input images using the plurality of feature maps and the trained parameters of the positional deviation prediction unit stored in the storage apparatus. Then the candidate area selection unit selects a set of candidate areas including the detection target from each of the plurality of input images based on the predicted amount of positional deviation. In this case, the plurality of feature maps are the ones extracted using the parameters of the trained feature map extraction unit stored in the storage apparatus from the plurality of input images captured by the plurality of modals. Accordingly, it is possible to accurately predict the positional deviation and select a set of candidate areas with high accuracy.

It is also possible to predict the detection areas for a plurality of modals and use the results of the prediction as a final output. In this case, it is possible to calculate the distance to the detected target from the magnitude of the amount of the positional deviation of the result and the arrangement of the cameras.

In order to eliminate the positional deviation, it may be possible to capture images in such a way that the optical axes of the plurality of cameras that correspond to the plurality of respective modals coincide with each other. However, in order to achieve this situation, it is required to provide a special image-capturing device adjusted in an arrangement that distributes light from a direction common to the plurality of cameras using a beam splitter or the like. Meanwhile, by using the technique according to this example embodiment, the deviation of the optical axes is allowed and a plurality of cameras installed simply parallel to each other can be used.

### Other Example Embodiments

While the aforementioned example embodiments have been described as a hardware configuration, the present disclosure is not limited to these example embodiments. This disclosure is able to achieve desired processing by causing a Central Processing Unit (CPU) to execute a computer program.

In the aforementioned examples, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, Digital Versatile Disc (DVD), and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above example embodiments and may be changed as appropriate without departing from the spirit of the present disclosure. Further, the present disclosure may be executed by combining example embodiments as appropriate.

The whole or a part of the exemplary embodiments disclosed above can be described as, but not limited to, the following supplementary notes.

### (Supplementary Note 1)

An image processing apparatus comprising:

determination means for determining, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images; and

a first learning means for learning, based on a plurality of feature maps extracted from each of the plurality of images, a set of the results of the determination made by the determination means for each of the plurality of images, and the ground truth, a first parameter used when an amount of positional deviation between the position of the detection target included in a first image captured by a first modal and the position of the detection target included in a second image captured by a second modal is predicted and storing the learned first parameter in a storage means.

### (Supplementary Note 2)

The image processing apparatus according to Supplementary Note 1, wherein the first learning means learns the first parameter using the difference between each of the plurality of ground truth areas in a set of the results of the determination in which the degree is equal to or larger than a predetermined value and a predetermined reference area in the detection target as the amount of positional deviation.

### (Supplementary Note 3)

The image processing apparatus according to Supplementary Note 2, wherein the first learning means uses one of the plurality of ground truth areas or an intermediate position of the plurality of ground truth areas as the reference area.

### (Supplementary Note 4)

The image processing apparatus according to any one of Supplementary Notes 1 to 3, further comprising:

a second learning means for learning, based on the set of the results of the determination and the feature maps, a second parameter used to calculate a score indicating a degree of the detection target with respect to the candidate area and storing the learned second parameter in the storage means; and

a third learning means for learning, based on the set of the results of the determination and the feature maps, a third parameter used to perform regression to make the position and the shape of the candidate area close to a ground truth area used for the determination and storing the learned third parameter in the storage means.

### (Supplementary Note 5)

The image processing apparatus according to any one of Supplementary Notes 1 to 4, further comprising:

a fourth learning means for learning, based on the set of the results of the determination, a fourth parameter used to extract the plurality of feature maps from each of the plurality of images and storing the learned fourth parameter in the storage means, wherein

the first learning means learns the first parameter using the plurality of feature maps extracted from each of the plurality of images using the fourth parameter stored in the storage means.

### (Supplementary Note 6)

The image processing apparatus according to Supplementary Note 5, further comprising a fifth learning means for learning a fifth parameter that fuses the plurality of feature maps and is used to identify the candidate areas and storing the learned fifth parameter in the storage means.

### (Supplementary Note 7)

The image processing apparatus according to Supplementary Note 5 or 6, further comprising candidate area selection means for predicting, using a plurality of feature maps extracted using the fourth parameter stored in the storage means from a plurality of input images captured by the plurality of modals and the first parameter stored in the storage means, an amount of positional deviation in the detection target between the input images, and selecting a set of candidate areas including the detection target from each of the plurality of input images based on the predicted amount of positional deviation.

### (Supplementary Note 8)

The image processing apparatus according to any one of Supplementary Notes 1 to 7, wherein each of the plurality of images is captured by a plurality of cameras that correspond to the plurality of respective modals.

### (Supplementary Note 9)

The image processing apparatus according to any one of Supplementary Notes 1 to 7, wherein each of the plurality of images is captured by one camera which is being moved while switching the plurality of modals at predetermined intervals. (Supplementary Note 10)

An image processing system comprising:

a first storage means for storing a plurality of images obtained by capturing a specific detection target by a plurality of different modals and a ground truth associating a plurality of ground truth areas, each ground truth area including a detection target in each of the plurality of images, with a ground truth label attached to the detection target;

a second storage means for storing a first parameter that is used to predict an amount of positional deviation between a position of the detection target included in a first image captured by a first modal and a position of the detection target included in a second image captured by a second modal;

determination means for determining, using the ground truth, a degree to which each of a plurality of candidate areas that correspond to respective predetermined positions common to the plurality of images includes a corresponding ground truth area for each of the plurality of images; and

a first learning means for learning, based on a plurality of features maps extracted from each of the plurality of images, a set of the results of the determination made by the determination means for each of the plurality of images, and the ground truth, the first parameter and storing the learned first parameter in the second storage means.

### (Supplementary Note 11)

The image processing system according to Supplementary Note 10, wherein the first learning means learns the first parameter using the difference between each of the plurality of ground truth areas in a set of the results of the determination in which the degree is equal to or larger than a predetermined value and the predetermined reference area in the detection target as the amount of positional deviation.

### (Supplementary Note 12)

An image processing method, wherein an image processing apparatus performs the following processing of:

determining, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images;

learning, based on a plurality of feature maps extracted from each of the plurality of images, a set of the results of the determination for each of the plurality of images, and the ground truth, a first parameter used when an amount of positional deviation between the position of the detection target included in a first image captured by a first modal and the position of the detection target included in a second image captured by a second modal is predicted; and

storing the learned first parameter in a storage apparatus.

### (Supplementary Note 13)

A non-transitory computer readable medium storing an image processing program for causing a computer to execute the following processing of:

determining, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images;

learning, based on a plurality of feature maps extracted from each of the plurality of images, a set of the results of the determination for each of the plurality of images, and the ground truth, a first parameter used when an amount of positional deviation between the position of the detection target included in a first image captured by a first modal and the position of the detection target included in a second image captured by a second modal is predicted; and

storing the learned first parameter in a storage apparatus.

### REFERENCE SIGNS LIST

1 Image Processing Apparatus
11 Determination Unit
12 Learning Unit
13 Storage Unit
14 Parameter
101 Storage Apparatus
1011 Program
1012 Parameter
102 Memory
103 Processor
1000 Image Processing System
1000a Image Processing System
100 Storage Apparatus
110 Learning Data
120 Multimodal image
121 Modal A Image
122 Modal B Image
130 Ground Truth
131 Ground Truth Area
132 Ground Truth Area
133 Ground Truth Label
200 Storage Apparatus
210 Dictionary
220 Dictionary
221 Dictionary
222 Dictionary
223 Dictionary
230 Dictionary
310 Feature Map Extraction Unit Learning Block
311 Feature Map Extraction Unit
312 Learning Unit
320 Area Candidate Selection Unit Learning Block
321 Score Calculation Unit Learning Block
3211 Determination Unit
3212 Score Calculation Unit
3213 Learning Unit
322 Bounding Box Regression Unit Learning Block
3222 Bounding Box Regression Unit
3223 Learning Unit
323 Positional Deviation Prediction Unit Learning Block
3232 Positional Deviation Prediction Unit
3233 Learning Unit
330 Modal Fusion Identification Unit Learning Block
331 Modal Fusion Identification Unit
332 Learning Unit
41 Set of Input Images
411 Input Image
4111 Background Object
4112 Person
412 Input Image
4121 Background Object
4122 Person
42 Set of Detection Candidate Areas
421 Image
4211 Background Object
4212 Person
4213 Detection Candidate Area
4214 Detection Candidate Area
422 Image
4221 Background Object
4222 Person
4223 Detection Candidate Area
4224 Detection Candidate Area
431 Output Image
4311 Detection Candidate Area
4312 Detection Candidate Area
4313 Label
4314 Label
500 Storage Apparatus
510 Input data
520 Multimodal image
521 Modal A Image
522 Modal B Image
530 Output data
611 Modal Image Input Unit
612 Modal Image Input Unit
620 Image Recognition Processing Block
621 Feature Map Extraction Unit
622 Feature Map Extraction Unit
623 Area Candidate Selection Unit
6231 Score Calculation Unit
6232 Bounding Box Regression Unit
6233 Positional Deviation Prediction Unit
6234 Selection Unit
6235 Calculation Unit
624 Cut-out Unit
625 Cut-out Unit
626 Modal Fusion Identification Unit
627 Detection Candidate Area
628 Detection Candidate Area
630 Output Unit

What is claimed is:

1. An image processing apparatus comprising:
at least one memory storing instructions, and
at least one processor configured to execute the instructions to:
determine, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images; and
learn, based on a plurality of feature maps extracted from each of the plurality of images, a set of the results of the determination made by the determination means for each of the plurality of images, and the ground truth, a first parameter used when an amount of positional deviation between the position of the detection target included in a first image captured by a first modal and the position of the detection target included in a second image captured by a second modal is predicted and store the learned first parameter in a storage means.

2. The image processing apparatus according to claim 1, wherein the at least one processor further configured to execute the instructions to learn the first parameter using the difference between each of the plurality of ground truth areas in a set of the results of the determination in which the degree is equal to or larger than a predetermined value and a predetermined reference area in the detection target as the amount of positional deviation.

3. The image processing apparatus according to claim 2, wherein the at least one processor further configured to execute the instructions to use one of the plurality of ground truth areas or an intermediate position of the plurality of ground truth areas as the reference area.

4. The image processing apparatus according to claim 1,
wherein the at least one processor further configured to execute the instructions to
learn, based on the set of the results of the determination and the feature maps, a second parameter used to calculate a score indicating a degree of the detection target with respect to the candidate area and store the learned second parameter in the storage means; and
learn, based on the set of the results of the determination and the feature maps, a third parameter used to perform regression to make the position and the shape of the candidate area close to a ground truth area used for the determination and store the learned third parameter in the storage means.

5. The image processing apparatus according to claim 1,
wherein the at least one processor further configured to execute the instructions to
learn, based on the set of the results of the determination, a fourth parameter used to extract the plurality of feature maps from each of the plurality of images and store the learned fourth parameter in the storage means, wherein
learn the first parameter using the plurality of feature maps extracted from each of the plurality of images using the fourth parameter stored in the storage means.

6. The image processing apparatus according to claim 5,
wherein the at least one processor further configured to execute the instructions to
learn a fifth parameter that fuses the plurality of feature maps and is used to identify the candidate areas and store the learned fifth parameter in the storage means.

7. The image processing apparatus according to claim 5,
wherein the at least one processor further configured to execute the instructions to
predict, using a plurality of feature maps extracted using the fourth parameter stored in the storage means from a plurality of input images captured by the plurality of modals and the first parameter stored in the storage means, an amount of positional deviation in the detection target between the input images, and select a set of candidate areas including the detection target from each of the plurality of input images based on the predicted amount of positional deviation.

8. The image processing apparatus according to claim 1, wherein each of the plurality of images is captured by a plurality of cameras that correspond to the plurality of respective modals.

9. The image processing apparatus according to claim 1, wherein each of the plurality of images is captured by one camera which is being moved while switching the plurality of modals at predetermined intervals.

10. (canceled)

11. (canceled)

12. An image processing method, wherein an image processing apparatus performs the following processing of:
determining, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images;
learning, based on a plurality of feature maps extracted from each of the plurality of images, a set of the results of the determination for each of the plurality of images, and the ground truth, a first parameter used when an amount of positional deviation between the position of the detection target included in a first image captured by a first modal and the position of the detection target included in a second image captured by a second modal is predicted; and
storing the learned first parameter in a storage apparatus.

13. A non-transitory computer readable medium storing an image processing program for causing a computer to execute the following processing of:
determining, using a ground truth associating a plurality of ground truth areas, each ground truth area including a detection target in each of a plurality of images obtained by capturing a specific detection target by a plurality of different modals, with a ground truth label attached to the detection target, a degree to which each of a plurality of candidate areas that correspond to respective predetermined positions common to the plurality of images includes a corresponding ground truth area for each of the plurality of images;
learning, based on a plurality of feature maps extracted from each of the plurality of images, a set of the results of the determination for each of the plurality of images, and the ground truth, a first parameter used when an amount of positional deviation between the position of the detection target included in a first image captured by a first modal and the position of the detection target included in a second image captured by a second modal is predicted; and
storing the learned first parameter in a storage apparatus.
